(19) United States
(12) Patent Application Publication
(10) Pub. No.: US 2025/0087926 A1
(43) Pub. Date: Mar. 13, 2025

(54) SHUTTER STRUCTURE OF SOCKET

(71) Applicant: Yunhua Lin, Wenzhou City (CN)

(72) Inventor: Yunhua Lin, Wenzhou City (CN)

(21) Appl. No.: 18/463,310

(22) Filed: Sep. 8, 2023

(51) Int. Cl. H01R 13/453

(52) U.S. Cl. CPC H01R 13/4534

(57) ABSTRACT

A shutter structure of a socket is disclosed in the present invention. The shutter structure of a socket includes a housing with an upward opening, where a left shutter mechanism and a right shutter mechanism allowing a plug inserting rod to be inserted in are arranged in the housing in an elastic sliding manner; and each of the left shutter mechanism and the right shutter mechanism includes a reset spring and a slide frame, the slide frame includes a side plate, a front transverse plate and a rear transverse plate which are integrally formed, one sides of the rear transverse plates on two sides facing inwards are provided with rear stress surfaces. According to the shutter structure of a socket, the slide frames can be strengthened, a slidable distance of the two slide frames is not influenced, and insertion of a plug is effectively guaranteed.

### TECHNICAL FIELD

The preset invention relates to a safety socket, in particular to a shutter structure of a socket.

### BACKGROUND

The utility model with a notification number of CN219393791U discloses a socket shutter protective device, which includes a device body. A boss is arranged on the device body, a reinforcing plate is arranged on a side of the boss, the reinforcing plate and the boss are integrally formed, a limiting baffle is arranged on a side of the device body, and the limiting baffle is of a bending structure. A first spring groove is formed in the boss, a second spring groove is formed in the other side surface of the device body, and the first spring groove and the second spring have the same direction. A first jack and a second jack are formed on the device body, and the first jack and the second jack are located on two sides of the boss. A first protective plate and a second protective plate are arranged in the device body, and the first protective plate and the second protective plate are arranged in the device body in a slide manner and shield or open the first jack and the second jack. A groove is formed on the first protective plate, and a first inclined plate is arranged in the groove. A first reset spring is arranged between the first protective plate and the second spring groove, and a second reset spring is arranged between the second protective plate and the first spring groove. A second inclined plate is arranged on a side of the second protective plate away from the boss, and the first inclined plate and the second inclined plate shield or open the first jack and the second jack.

However, the protective plates corresponding to the two jacks of the socket shutter protective device are not evenly opened, and actions are difficult to coordinate, so the hand feeling is poor.

### SUMMARY

In view of the shortcomings in the background art, the technical problem to be solved by the present invention is to provide a shutter structure of a socket with more uniform stress on shutters at two sides, more coordinated opening action and better hand feeling.

Therefore, the shutter structure of a socket provided in the present invention includes a housing with an upward opening, where a left shutter mechanism and a right shutter mechanism allowing a plug inserting rod to be inserted in are arranged in the housing in an elastic sliding manner; and each of the left shutter mechanism and the right shutter mechanism includes a reset spring and a slide frame, the slide frame includes a side plate, a front transverse plate and a rear transverse plate which are integrally formed, the front transverse plate and the rear transverse plate are parallel to each other and are transversely perpendicular to the side plate, one side of the front transverse plate facing outwards is provided with a front stress surface, the front stress surface is an arc surface or an inclined surface, the front transverse plate and the side plate are provided with an integrally formed triangular reinforcing plate, the rear transverse plate is distributed in a step shape, a lower side of a front end of the front transverse plate is distributed in a step shape, the triangular reinforcing plate and the rear transverse plate have the same thickness and have bottoms located on a same horizontal plane, the two slide frames are oppositely superposed, a step surface of the front transverse plate on the left slide frame is placed on a step surface of the rear transverse plate on the right slide frame under a state of no external force, a step surface of the front transverse plate on the right slide frame is placed on a step surface of the rear transverse plate on the left slide frame, the reset spring is arranged between an outer end of the left slide frame and an inner wall of the housing, the reset spring is arranged between an outer end of the right slide frame and the inner wall of the housing, the side plate of the left slide frame and the side plate of the right slide frame are oppositely arranged, socket holes are provided just above the inclined surfaces or arc surfaces of the front transverse plates of the left shutter mechanism and the right shutter mechanism, one sides of the rear transverse plates on two sides facing inwards are provided with rear stress surfaces, and the rear stress surfaces are arc surfaces or inclined surfaces.

Preferably, an inner inclined surface of the left triangular reinforcing plate is parallel to an inner inclined surface of the right triangular reinforcing plate.

Preferably, an outer surface of the slide frame is provided with a limiting block, the housing is provided with a limiting hole corresponding to the limiting block, and the limiting block is inserted in the limiting hole, such that slide guide and limiting for the slide frames on the two sides are implemented.

Preferably, a groove is provided on an outer side of the rear transverse plate close to the inclined surface or arc surface, and the groove is opposite the socket hole when not acted by external force.

The present invention has the following technical effects.

According to the shutter structure of a socket provided in the present invention, the slide frames on the two sides are identical in structure or consistent in main structure, and the two slide frames have the same distribution positions after mutual rotation and overlap, such that resistances of the inclined surfaces of the front transverse plates on the slide frames are relatively consistent when the inclined planes are pushed by an end of a plug, and the hand feeling of the plug is better during insertion.

In the present invention, the rear transverse plate of the slide frame is provided with the upward inclined surface, which can assist insertion of the plug inserting rod. For example, when insertion of the plug is not standard, the inserting rod on one side is inserted firstly, and the inserting rod on the other side is inserted later, such that movement of the rear transverse plate is not timely enough, the rear transverse plate partially blocks a lower portion of the inserting rod, and in this case, the rear transverse plate of the lower slide frame can be continuously pushed because the rear stress surface of the rear transverse plate is provided with an inclined surface, such that the plug is prevented from being blocked by the rear transverse plate.

The groove in the rear transverse plate can bear an end of a single rod when the rod is inserted, such that when the single rod is clamped and cannot be further inserted, the structure of the groove can better prevent sliding, and then a better effect is achieved.

The inner inclined plane of the left triangular reinforcing plate is parallel to the inner inclined plane of the right triangular reinforcing plate, and such a structure enables the reinforcing plates to avoid collision to the greatest extent, such that a movement and receding space as large as possible can be obtained, and furthermore, structural reinforcement is considered.

### BRIEF DESCRIPTION OF THE DRAWINGS

FIG. 1 is a schematic structural plane view of a shutter structure of a socket provided in the present invention;

FIG. 2 is a schematic diagram of a three-dimensional structure of the shutter structure of a socket in FIG. 1;

FIG. 3 is a schematic diagram of a three-dimensional structure of a left slide frame in FIG. 2; and

FIG. 4 is a schematic diagram of separated structures of the slide frames in FIG. 2.

### DETAILED DESCRIPTION OF THE EMBODIMENTS

In order to further describe the technical means and effects adopted by the present invention for achieving predetermined objectives of the present invention, specific embodiments, structures, features and effects according to the present invention are described in detail below with reference to the accompanying drawings and preferred examples.

For clarity of orientation, the left and right in this patent refer to the left and right sides facing the drawing.

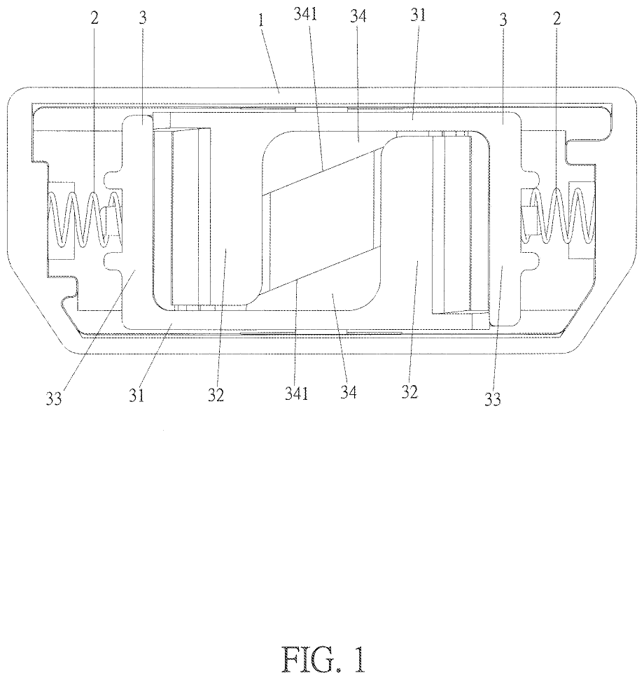

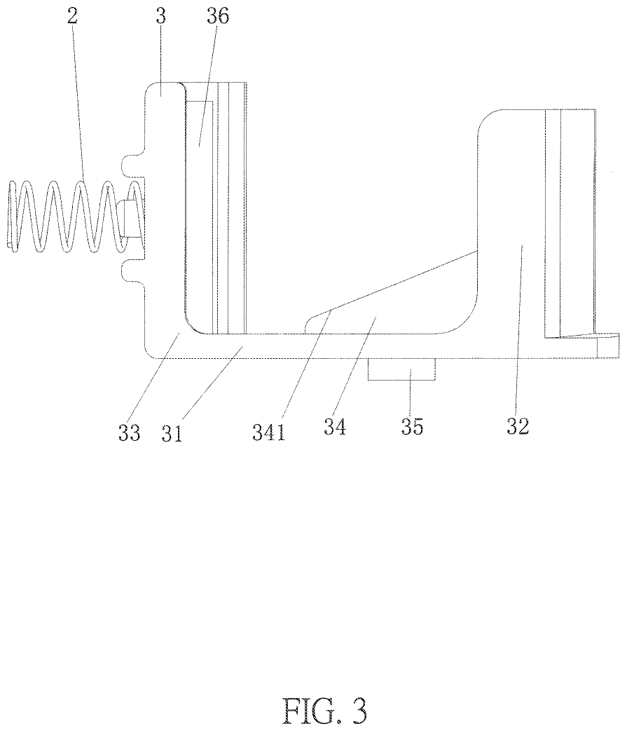

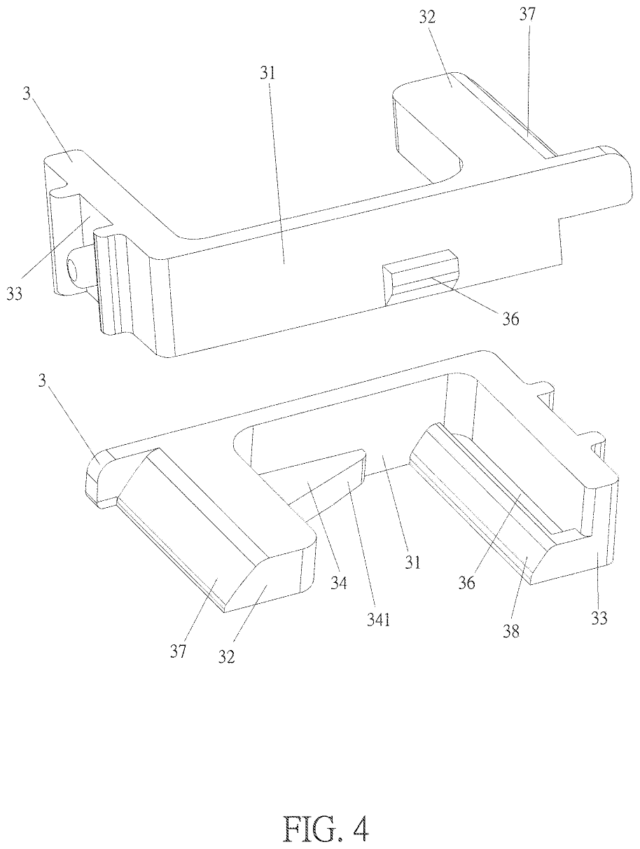

With reference to FIGS. 1-4, the shutter structure of a socket provided in the present invention includes a housing 1 with an upward opening, where a left shutter mechanism and a right shutter mechanism allowing a plug inserting rod to be inserted in are arranged in the housing 1 in an elastic sliding manner. Each of the left shutter mechanism and the right shutter mechanism includes a reset spring 2 and a slide frame 3. The slide frame 3 includes a side plate 31, a front transverse plate 32 and a rear transverse plate 33 which are integrally formed. The front transverse plate 32 and the rear transverse plate 33 are parallel to each other and are transversely perpendicular to the side plate 31. One side of the front transverse plate 32 facing outwards is provided with a front stress surface 37. The front stress surface 37 is an arc surface or an inclined surface. The front transverse plate 32 and the side plate 31 are provided with an integrally formed triangular reinforcing plate 34. The rear transverse plate 33 is distributed in a step shape, and a step surface is arranged upwards. A lower side of a front end of the front transverse plate 32 is distributed in a step shape. The triangular reinforcing plate 34 and the rear transverse plate 33 have the same thickness and have bottoms located on a same horizontal plane. The two slide frames 3 are oppositely superposed and staggered with each other. A step surface of the front transverse plate 32 on the left slide frame 3 is placed on a step surface of the rear transverse plate 33 on the right slide frame 3 under a state of no external force, and a step surface of the front transverse plate 32 on the right slide frame 3 is placed on a step surface of the rear transverse plate 33 on the left slide frame 3. The reset spring 2 is arranged between an outer end of the left slide frame 3 and an inner wall of the housing 1, and the reset spring 2 is arranged between an outer end of the right slide frame 3 and the inner wall of the housing 1. The side plate 31 of the left slide frame 3 and the side plate 31 of the right slide frame 3 are oppositely arranged. Socket holes are provided just above the inclined surfaces or arc surfaces of the front transverse plates 32 of the left shutter mechanism and the right shutter mechanism. An inner inclined surface 341 of the left triangular reinforcing plate 34 is parallel to an inner inclined surface 341 of the right triangular reinforcing plate 34. When two plugs are inserted, the plugs push against the inclined surfaces or arc surfaces of the front transverse plates 32 on the left and right sides respectively, drive the two slide frames 3 to slide to the two sides, and compress the reset springs 2 on the two sides respectively, so as to open a plug-in connecting channel. One sides of the rear transverse plates 33 on two sides facing inwards are provided with rear stress surfaces 38, and the rear stress surfaces 38 are arc surfaces or inclined surfaces which can assist insertion of the plug inserting rod. For example, when insertion of the plug is not standard, the inserting rod on one side is inserted firstly, and the inserting rod on the other side is inserted later, such that movement of the rear transverse plate is not timely enough, the rear transverse plate partially blocks a lower portion of the inserting rod, and in this case, the rear transverse plate of the lower slide frame can be continuously pushed because the rear stress surface of the rear transverse plate is provided with an inclined surface, such that the plug is prevented from being blocked by the rear transverse plate.

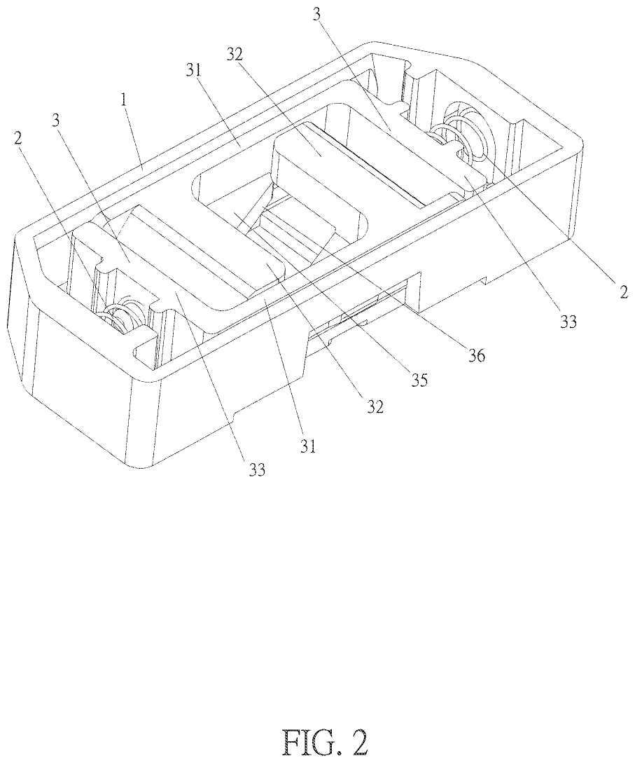

With reference to FIGS. 2-4, a groove 36 is provided on an outer side of the rear transverse plate 33 close to the inclined surface or arc surface, and the groove 36 is opposite the socket hole when not acted by external force. The groove in the rear transverse plate can bear an end of a single rod when the rod is inserted, such that when the single rod is clamped and cannot be further inserted, the structure of the groove can better prevent sliding, and then a better effect is achieved.

With reference to FIGS. 1, 3 and 4, an outer surface of the slide frame is provided with a limiting block 35, the housing 1 is provided with a limiting hole 11 corresponding to the limiting block, the limiting hole 11 is of a transverse strip shape, and the limiting block 35 is inserted in the limiting hole 11, such that slide guide and limiting for the slide frames 3 on the two sides are implemented.

With reference to FIGS. 1-4, a working principle of the shutter structure of a socket is as follows:

When a single rod is inserted in a jack, the single rod can push an inclined surface of a front transverse plate 32 of a slide frame 3 at a corresponding position, and then push the slide frame 3 to move, but since a slide frame 3 on the other side is not pushed with no rod, a rear transverse plate 33 of the slide frame 3 on the other side still blocks the jack, and then the rod is prevented from being inserted further, such that safety is guaranteed.

When a double-inserting-rod plug is inserted, the inclined surfaces of the front transverse plates 32 of the slide frames 3 on two sides are pushed simultaneously, and then move to the two sides and separate, and the rear transverse plates 33 also move synchronously, such that all passages leading to a lower portion can be opened, and the plug can be inserted and connected.

The foregoing descriptions are merely preferred examples of the present invention, and are not intended to limit the present invention in any form. Although the present invention has been disclosed as above by means of the preferred examples, these examples are not for defining the present invention. Those skilled in the art can make certain alterations or modifications by using the technical contents disclosed above without departing from the scope of the technical solutions of the present invention, so as to arrive at equivalent examples with equivalent changes. However, any simple amendments, equivalent changes, and modifications made to the above examples according to the technical essence of the present invention without departing from the contents of the technical solutions of the present invention still fall within the scope of the technical solutions of the present invention.

I claim:

1. A shutter structure of a socket, comprising
a housing with an upward opening, wherein a left shutter mechanism and a right shutter mechanism allowing a plug inserting rod to be inserted in are arranged in the housing in an elastic sliding manner; and each of the left shutter mechanism and the right shutter mechanism comprises a reset spring and a slide frame, the slide frame comprises a side plate, a front transverse plate and a rear transverse plate which are integrally formed, the front transverse plate and the rear transverse plate are parallel to each other and are transversely perpendicular to the side plate, one side of the front transverse plate facing outwards is provided with a front stress surface, the front stress surface is an arc surface or an inclined surface, the front transverse plate and the side plate are provided with an integrally formed triangular reinforcing plate, the rear transverse plate is distributed in a step shape, a lower side of a front end of the front transverse plate is distributed in a step shape, the triangular reinforcing plate and the rear transverse plate have the same thickness and have bottoms located on a same horizontal plane, the two slide frames are oppositely superposed and have the same position distribution after mutual rotation, a step surface of the front transverse plate on the left slide frame is placed on a step surface of the rear transverse plate on the right slide frame under a state of no external force, a step surface of the front transverse plate on the right slide frame is placed on a step surface of the rear transverse plate on the left slide frame, the reset spring is arranged between an outer end of the left slide frame and an inner wall of the housing, the reset spring is arranged between an outer end of the right slide frame and the inner wall of the housing, the side plate of the left slide frame and the side plate of the right slide frame are oppositely arranged, socket holes are provided just above the inclined surfaces or arc surfaces of the front transverse plates of the left shutter mechanism and the right shutter mechanism, one sides of the rear transverse plates on two sides facing inwards are provided with rear stress surfaces, and the rear stress surfaces are arc surfaces or inclined surfaces.

2. The shutter structure of a socket according to claim 1, wherein an inner inclined surface of the left triangular reinforcing plate is parallel to an inner inclined surface of the right triangular reinforcing plate.

3. The shutter structure of a socket according to claim 1, wherein an outer surface of the slide frame is provided with a limiting block, the housing is provided with a limiting hole corresponding to the limiting block, and the limiting block is inserted in the limiting hole, such that slide guide and limiting for the slide frames on the two sides are implemented.

4. The shutter structure of a socket according to claim 1, wherein a groove is provided on an outer side of the rear transverse plate close to the inclined surface or arc surface, and the groove is opposite the socket hole when not acted by external force.

5. The shutter structure of a socket according to claim 3, wherein a groove is provided on an outer side of the rear transverse plate close to the inclined surface or arc surface, and the groove is opposite the socket hole when not acted by external force.
